(19) United States
(12) Patent Application Publication
(10) Pub. No.: US 2014/0192159 A1
(43) Pub. Date: Jul. 10, 2014

(54) CAMERA REGISTRATION AND VIDEO INTEGRATION IN 3D GEOMETRY MODEL

(71) Applicants: Henry Chen, Beijing (CN); Xiaoli Wang, Beijing (CN); Hao Bai, Beijing (CN); Saad J Ros, St. Paul, MN (US); Tom Plocher, Hugo, MN (US)

(72) Inventors: Henry Chen, Beijing (CN); Xiaoli Wang, Beijing (CN); Hao Bai, Beijing (CN); Saad J Ros, St. Paul, MN (US); Tom Plocher, Hugo, MN (US)

(73) Assignee: METROLOGIC INSTRUMENTS, INC., Blackwood, NJ (US)

(21) Appl. No.: 14/122,324

(22) PCT Filed: Jun. 14, 2011
(86) PCT No.: PCT/CN2011/000983

§ 371 Date: Feb. 28, 2014

(51) Int. Cl. G06T 15/00

(52) U.S. Cl. CPC G06T 15/00
USPC 348/46

(57) ABSTRACT

Apparatus, systems, and methods may operate to receive a real image or real images of a coverage area of a surveillance camera. Building Information Model (BIM) data associated with the coverage area may be received. A virtual image may be generated using the BIM data. The virtual image may include at least one three-dimensional (3-D) graphics that substantially corresponds to the real image. The virtual image may be mapped with the real image. Then, the surveillance camera may be registered in a BIM coordination system using an outcome of the mapping.

### CROSS REFERENCE TO RELATED APPLICATION

The present application is also related to U.S. Non-Provisional patent application Ser. No. 13/150,965 entitled “SYSTEM AND METHOD FOR AUTOMATIC CAMERA PLACEMENT” that was filed on the date of Jun. 1, 2011, the contents of which are incorporated by reference in their entirety.

### TECHNICAL FIELD

The present disclosure relates to a system and method for camera registration in three-dimensional (3-D) geometry model.

### BACKGROUND

The surveillance and monitoring of a building, a facility, a campus, or other area can be accomplished via the placement of a variety of cameras throughout the building, the facility, the campus, or the area. However, in the current state of the art, it is difficult to determine the most efficient and economical uses of the camera resources at hand.

### BRIEF DESCRIPTION OF THE DRAWINGS

FIG. 1 is a block diagram of a system to implement camera registration in 3-D geometry model according to various embodiments of the invention.

FIG. 2 is a flow diagram illustrating methods for implementing camera registration in 3-D geometry model according to various embodiments of the invention.

FIG. 3 is a block diagram of a machine in the example form of a computer system according to various embodiments of the invention.

FIG. 4A illustrates a virtual camera placed in a 3-D environment and a coverage area of the virtual camera according to various embodiments of the invention.

FIG. 4B illustrates a virtual image and a real image presented in a 3-D environment according to various embodiments of the invention.

FIG. 4C illustrates a virtual image and a real image with some features extracted from each of the virtual and real images according to various embodiments of the invention.

FIG. 4D illustrates a virtual image and a real image with corresponding features from each of the virtual and real images matched to each other according to various embodiments of the invention.

FIG. 4E illustrates addition, deletion, or modification of some matched pairs of features from a virtual image and a real image according to various embodiments of the invention.

FIG. 4F illustrates determining of intersection points of a corresponding pair of matching features from a virtual image and a real image according to various embodiments of the invention.

FIG. 4G illustrates repositioning of a virtual camera in a 3-D environment using refined extrinsic parameters according to various embodiments of the invention.

FIG. 4H illustrates integrating of an updated image from a real camera into a coverage area of a virtual camera in a 3-D environment according to various embodiments of the invention.

FIG. 4I illustrates determining whether a point in a 3-D environment is in shadow or illuminated according to various embodiments of the invention.

FIG. 4J is a flow diagram illustrating methods for implementing projection of a real image onto a coverage area of a virtual camera in a 3-D environment according to various embodiments of the invention.

FIG. 4K illustrates perspective constraint on a user's perspective in a 3-D environment according to various embodiments of the invention.

FIG. 4L illustrates distortion of an image according to various embodiments of the invention.

FIG. 4M is a flow diagram illustrating methods for implementing enforcement perspective constraints of a user according to various embodiments of the invention.

### DETAILED DESCRIPTION

Development of geometry technology, high-fidelity three-dimensional (3-D) geometry models of building, such as Building Information Model (BIM) or Industry Foundation Classes (IFC), and its data are becoming more and more popular. Such technology makes it possible to display cameras and their coverage area in a 3-D geometry model (hereinafter used interchangeably with “3-D model” or “3-D building model”). Three-dimension (3-D) based solutions allow providing more intuitive and higher usability for a video surveillance application, compared to two-dimension (2-D) based solutions. This is because the 3-D based solutions, for example, better visualize occlusions by objects in field of view (FOV) of a camera, such as a surveillance camera installed in or around a building or any other area. Applicants have realized that with camera parameters, such as a location (or position) (x, y, z) or an orientation (pan, tilt, zoom), in a 3-D model, it is possible to furthermore enhance the situation awareness, for example, via integrating a real video from the surveillance camera into the 3-D model.

However, automatic registration of a camera in the 3-D model is a difficult task. For example, it is difficult to place, for a real camera installed in or around a physical building or other area, a virtual camera simulating the real camera in a 3-D model view (or scene). Although the camera parameters may be imported from a camera planning system, there is almost always some offset between the camera parameters as planned and recorded in the camera planning system and the camera parameters as currently installed in a relevant location. For example, the installation of the camera may not be as precise as originally planned or, in some cases, the parameters of the camera, position or orientation, may need to be changed later in order to provide a better surveillance view.

Consequently, if the camera parameters imported from the planning system are directly used to get an image (e.g., video) for a coverage area of the (real) surveillance camera and then to map the image (that captures an actual view or scene) in the 3-D model, the image will not display as precise a view or scene as originally intended by a user (e.g., administrator of a camera system), providing the user with inconsistent description of a real situation. This causes lower user awareness in many security-related applications, such as a surveillance camera system. Thus, Applicants have realized that it is beneficial to adjust the virtual camera from the initial position or orientation based on the camera planning system to a refined position or orientation that reflects the actual position or orientation of the real camera more closely. This allows, for example, providing better situation awareness of the coverage area of the real camera in a 3-D environment (hereinafter used interchangeably with “3-D virtual environment”) provided by the 3-D model.

Conventional camera parameters registration is not only complex but also inaccurate because each reference point needs to be manually specified from a relevant 2-D image (e.g., 2-D video). In other words, the conventional system or method requires a user (e.g., system administrator) to micro-adjust the parameters of the virtual camera to match the coverage area of the real camera substantially precisely. For example, each pixel in a 2-D video will represent all points from the camera along a line, so camera registration technology is often used. However, traditional camera registration requires an auxiliary accessorial device, such as a planar (2-D) checkerboard.

Even if it is acceptable to place the auxiliary device in the environment, how to get the device geometry data becomes another difficult problem. The camera registration with the video scene itself is called “the self camera registration problem” and is still in question in the art. Applicants have also realized that to solve these problems, it is beneficial to use semantic data from the 3-D model, such as a building information model (BIM) model, to automate camera registration of the virtual camera in the 3-D model.

Some embodiments described herein may comprise a system, apparatus and method of automating camera registration, and/or video integration in a 3D environment, using BIM semantic data and a real video. In various embodiments, the real image (e.g., video) may be imported from a real camera (e.g., surveillance camera) physically installed in or around a building or other outdoor area (e.g., park or street). Rough (or initial) camera parameters, such as a position or orientation, of the real camera may also be obtained. The rough (or initial) parameters may be provided by a user, such as a system administrator, or automatically imported from a relevant system, such as a camera planning system as described in the cross-referenced application entitled “SYSTEM AND METHOD FOR AUTOMATIC CAMERA PLACEMENT.”

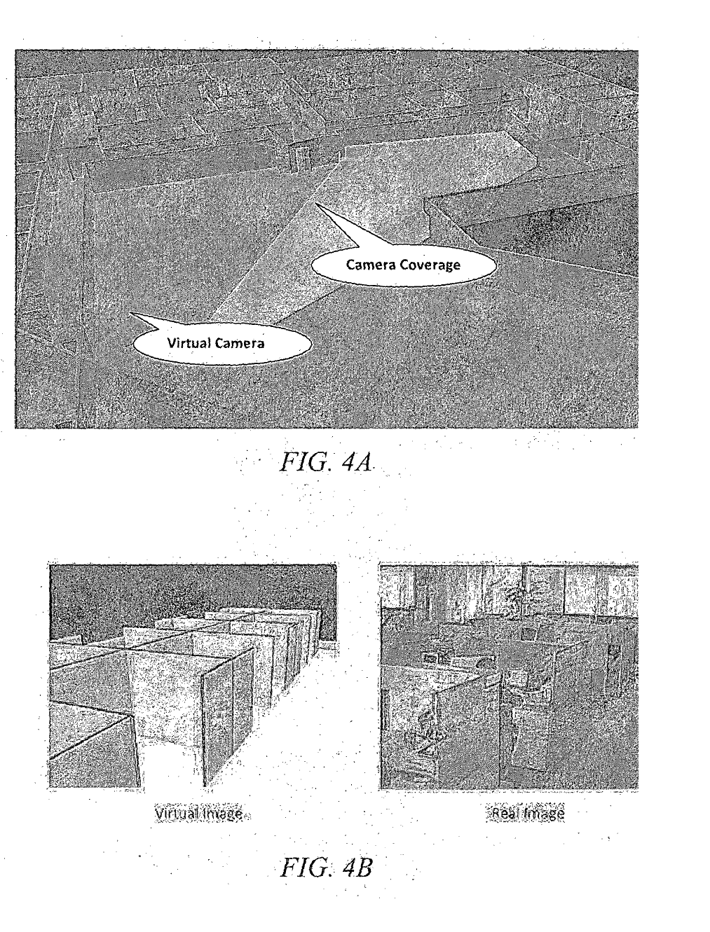

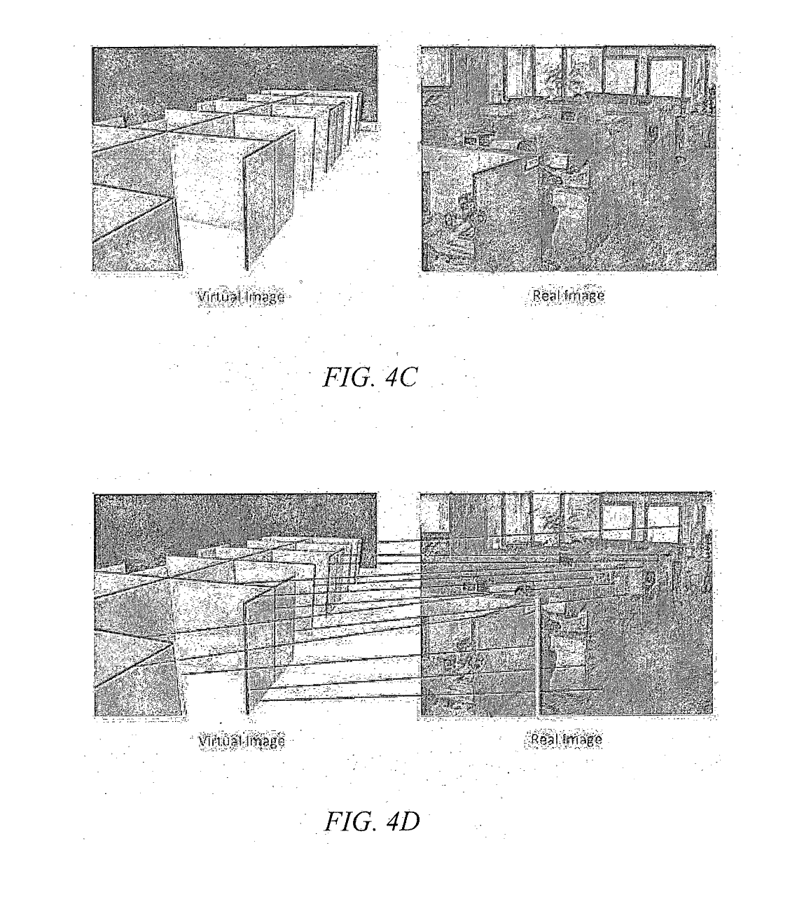

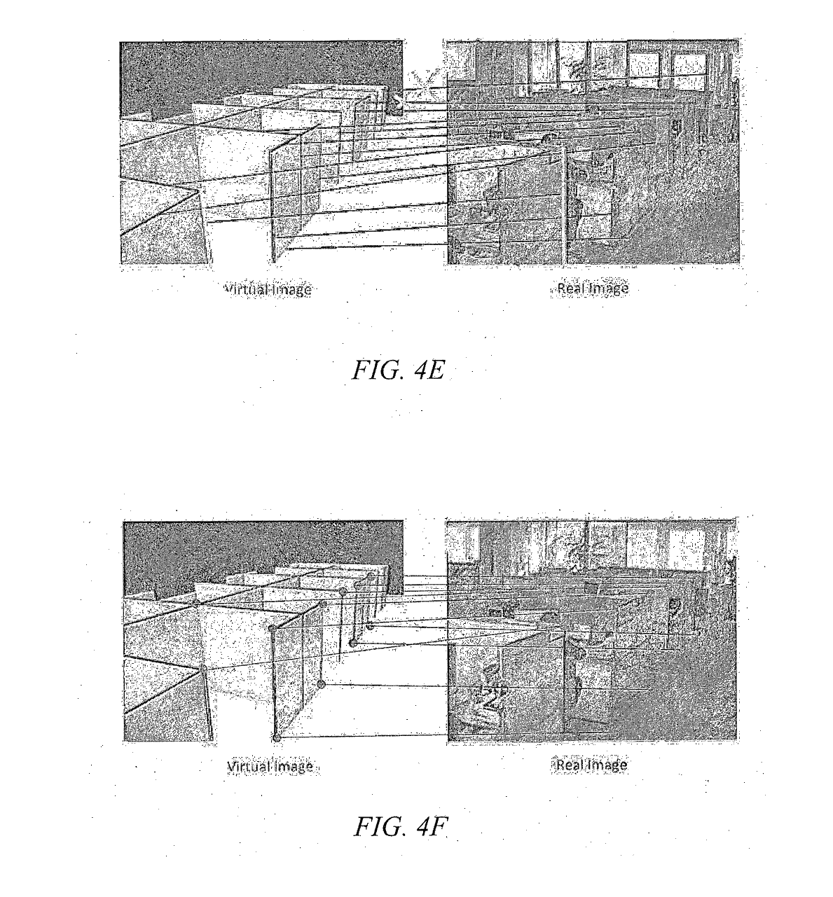

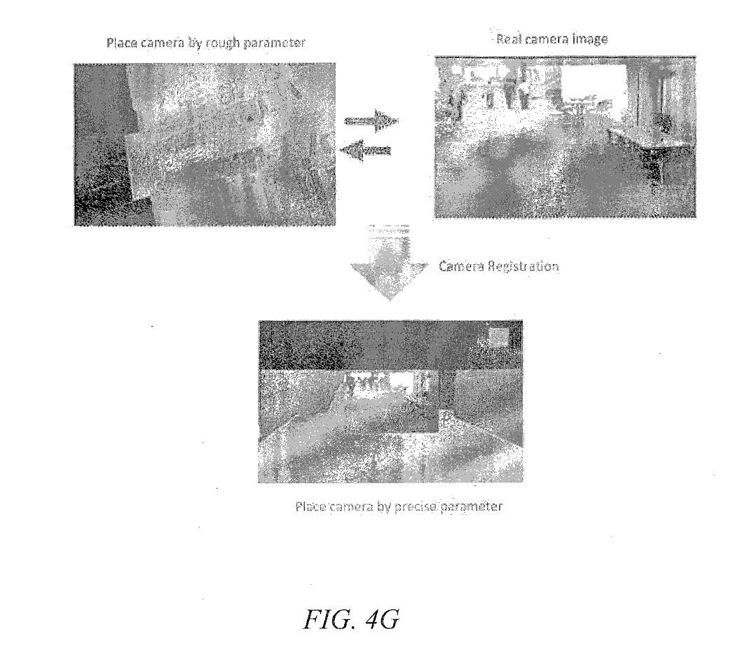

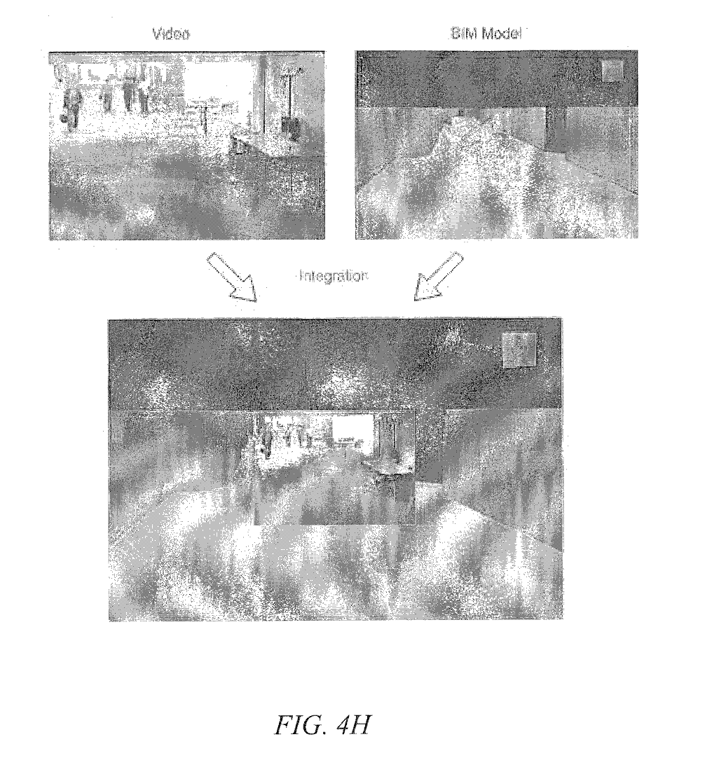

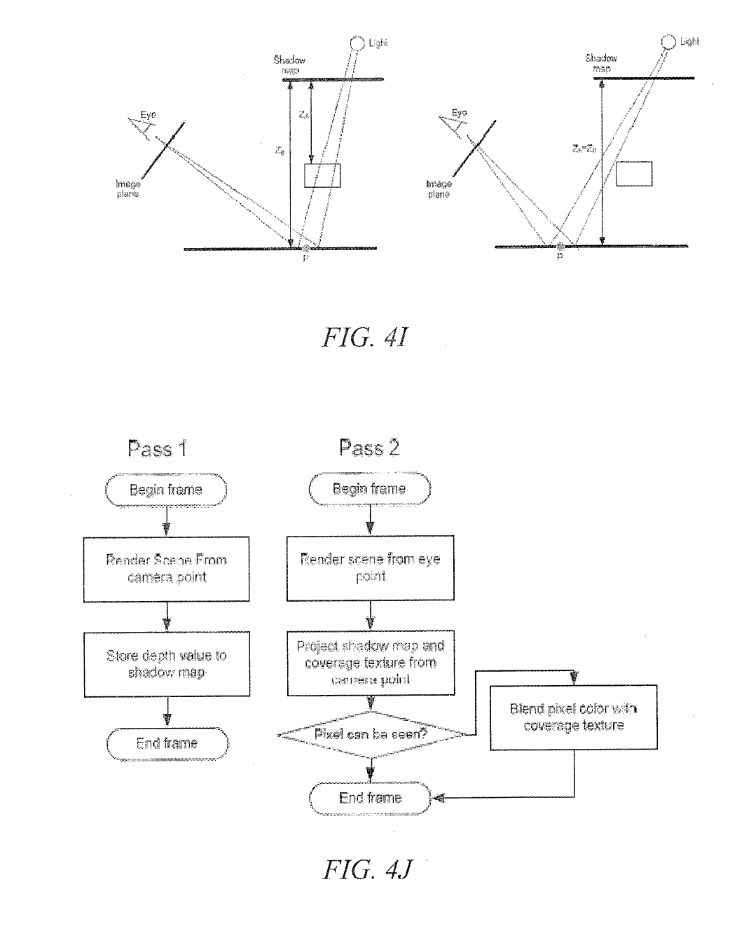

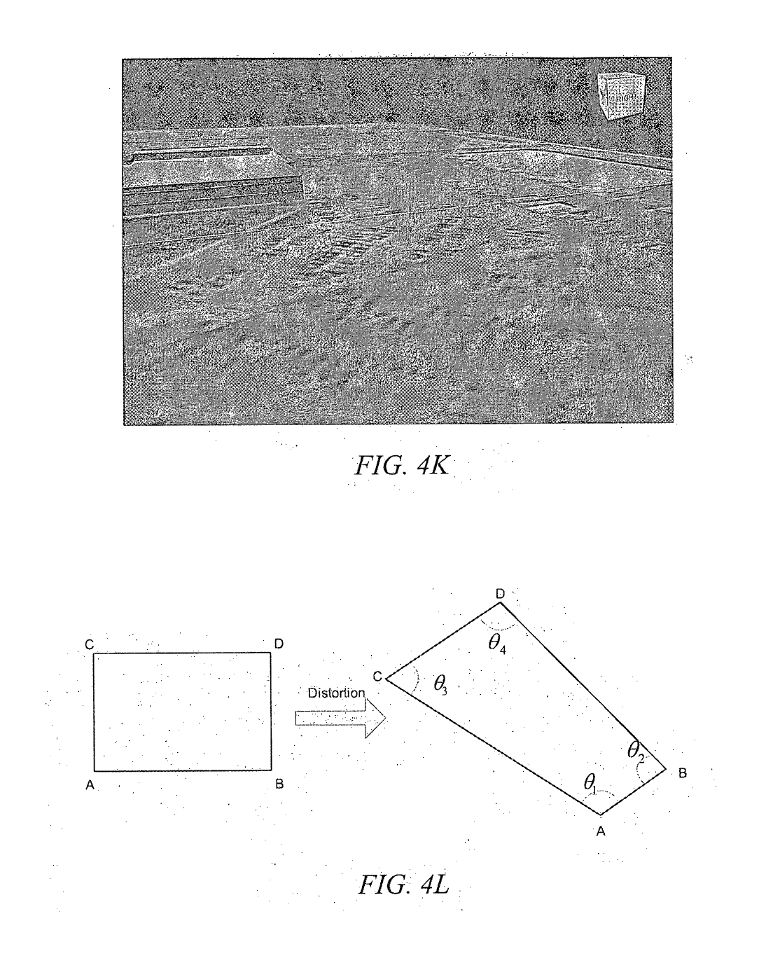

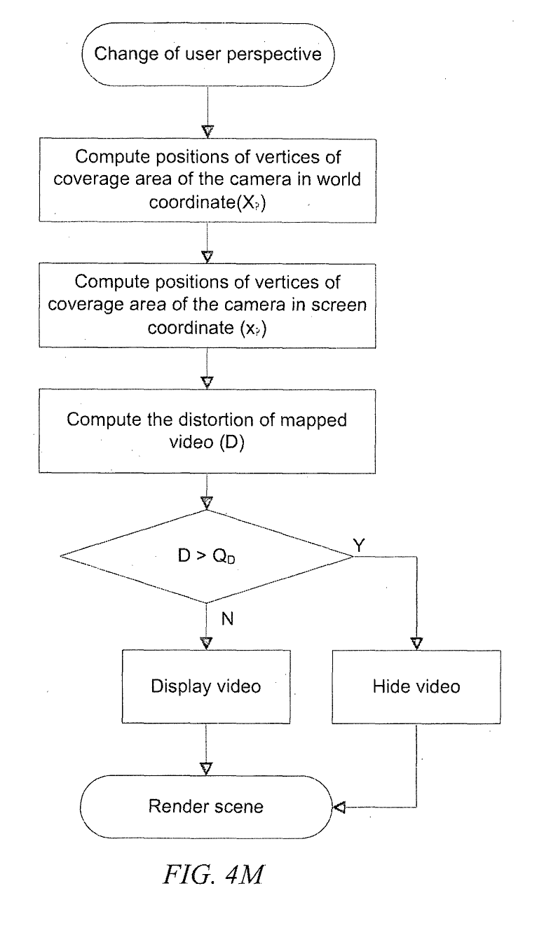

In various embodiments, as illustrated in FIG. 4A, a virtual camera that is configured to simulate the real camera may be placed in a 3-D environment, such as a 3-D geometry model provided by BIM, using the rough (or initial) camera parameters of the real camera. A virtual image that substantially corresponds to the real image may be presented in the 3-D environment along with the real image via a display device, as illustrated in FIG. 4B. The virtual image may be generated using semantic information associated with relevant BIM data. For example, the virtual image may include one or more graphic indications (or marks) for a corresponding feature, such as a geometric shape (e.g., circle, rectangle, triangle, line or edge, etc.), associated with an object or structure (e.g., cubicle, desk, wall, or window etc.) viewed in the virtual image.

Camera registration may then be performed, for example, using mapping information between the virtual image and the real image. To perform the mapping, feature points may be extracted from the virtual image and the real image, respectively, and then one or more of the extracted feature points may be matched to each other. Then, at least one pair of the matched points may be selected and marked as a matching pair.

In various embodiments, one or more points (or vertices) associated with at least one of the features in the virtual image may be mapped to a corresponding point (or vertex) associated with a matching feature in the real image, detecting one or more pairs of matching points. The mapping may be performed manually (i.e., as a function of one or more user inputs), automatically or by a combination thereof (e.g., heuristic basis).

In various embodiments, semantic information in a BIM model may be used to extract the features. For example, for a door in the field of view, the entire boundary of the door in the virtual image may be detected concurrently instead of detecting each edge at a time, using relevant semantic BIM data. Similarly, for a column, parallel lines may be detected concurrently instead of detecting its edges one by one. These geometric features may be automatically presented in the virtual image. The matching pair features in the real image from the real camera may be automatically selected using the semantic features.

Various algorithms may be used to match features between a virtual image and a corresponding real image. In various embodiments, as described in FIG. 4C, edges in the virtual image may be extracted and marked as graphically distinguished. The edges in the virtual image of a corresponding building or other area may be rendered in a special color, texture, shade, thickness or a combination thereof which is distinguished from the other components of the virtual image. In one example embodiment, as illustrated in FIG. 4C (left), the lines of the features (e.g., cubicles) are distinguished using a different color (e.g., blue). For the real image, as illustrated in FIG. 4C (right), image processing technology may be employed to abstract, for example, long straight lines in the real image. It is noticed that there are more edges in the real image than virtual image because there are some elements which are not created in the 3D model.

As illustrated in FIG. 4D, a pair of matching edges may be detected manually or automatically. In various embodiments, only one pair of edges (the yellow edges in FIG. 4D) needs to be matched manually to supply a bench mark edge for the automatic edges matching. Once the pair of bench mark edges is indicated, the edges in the virtual map near the mark edge will be automatically searched and selected, and a corresponding edge in the real image may be automatically found and matched based on the similarity of space relationship. If a new pair of edges is found, next edges near the new edges will be automatically selected and matched to each other, and so on. Then the pairs of the edges between the virtual image and the real image can be detected.

As illustrated in FIG. 4E, when there are not enough pairs of matching edges or there are some error matches, one or more pairs of edges may be additionally added to, or deleted or modified from, the corresponding virtual or real images. Such additional addition, deletion or modification of a matching pair may be performed manually, automatically or a combination thereof.

Then, as illustrated in FIG. 4F, the intersection point of a corresponding pair of edges may be determined from each of the virtual and real images as a pair of matching vertices. In various embodiments, the mapping process may be completed based on a determination that the number of pairs of matching points reaches a specified threshold number, such as one, two, three or six, etc.

Camera calibration may be further performed using the pairs of matching vertices (or points), computing refined (or substantially precise) camera parameters for the virtual camera as a function of a camera registration algorithm. Using the camera calibration process, the position and orientation of the virtual camera placed in the 3D environment that are the same as the position and orientation of the corresponding camera in the real world may be calculated.

Once the mapping process described above is completed, then two groups of matching points in the virtual image and the real image may be obtained:
Points in the virtual image: Pv1, Pv2 . . . Pvn; and
Points in the real image: Pr1, Pr2 . . . Prn, with Ps=(xs, ys, 1).
   The 3D points P3di (i=1, 2 . . . n) in the 3D environment can be computed by ray casting algorithm from the 2D point in the virtual image Pvi, with i=1, 2 . . . n. Then, the points in the real image Pri (i=1, 2 . . . n) and their corresponding points in the 3D environment P3di (i=1, 2 . . . n) can be calculated using P3ds=(Xs, Ys, Zs, 1).

In various embodiments, the following procedures and formulas may be used to perform the camera calibration by the corresponding points in the real image and 3D environment:

Step1: find a 3×4 matrix M, which satisfies Pᵣᵢ=MP_{3di}(i=1, 2 . . . n)

With

$$[ \begin{matrix}u \\ v \\ 1\end{matrix} ] = {M}_{3 \times 4} [ \begin{matrix}X \\ Y \\ Z \\ 1\end{matrix} ]$$

We can get:

m₁₁X+m₁₂Y+m₁₃Z+m₁₄−m₃₁uX−m₃₂uY−m₃₃uZ−m₃₄u=0

m₂₁X+m₂₂Y+m₂₃Z+m₂₄−m₃₁vX−m₃₂vY−m₃₃vZ−m₃₄v=0

Then, the following equation can be computed: AL=0, with A is a 2n*12 matrix, wherein:

$$A = [ \begin{matrix}{X}_{1} & {Y}_{1} & {Z}_{1} & 1 & 0 & 0 & 0 & 0 & - {u}_{1} {X}_{1} & - {u}_{1} {Y}_{1} & - {u}_{1} {Z}_{1} & - {u}_{1} \\ 0 & 0 & 0 & 0 & {X}_{1} & {Y}_{1} & {Z}_{1} & 1 & - {v}_{1} {X}_{1} & - {v}_{1} {Y}_{1} & - {v}_{1} {Z}_{1} & - {v}_{1} \\ … & & & & & & & & & & & \end{matrix} ] ;$$

$$and$$

$$L = [ \begin{matrix}{m}_{11} & {m}_{12} & {m}_{13} & {m}_{14} & {m}_{21} & {m}_{22} & {m}_{23} & {m}_{24} & {m}_{31} & {m}_{32} & {m}_{33} & {m}_{34}\end{matrix} ] .$$

Now, the proper L which minimizes ∥AL∥ may be calculated.
With the constraint of m₃₄=1, we can get L′=−(C^{T}C)⁻¹C^{T}B, wherein:

L′=[l₁, l₂ . . . l₁₁];

C=[a₁, a₂ . . . a₁₁];

B=[a₁₂].

Further, M can be calculated by L.

Step2: abstract the parameter matrix from M

For M=KR[I₃|−C], Left 3×3 sub matrix P of M is of form P=K R, wherein:
K is an upper triangular matrix;
R is an orthogonal matrix;
Any non-singular square matrix P can be decomposed into the product of an upper triangular matrix K and an orthogonal matrix R using the RQ factorization.
For

$$Rx = [ \begin{matrix}1 & 0 & 0 \\ 0 & c & - s \\ 0 & s & c\end{matrix} ] , Ry = [ \begin{matrix}{c}^{′} & 0 & {s}^{′} \\ 0 & 1 & 0 \\ - {s}^{′} & 0 & {c}^{′}\end{matrix} ] , Rz = [ \begin{matrix}{c}^{″} & - {s}^{″} & 0 \\ {s}^{″} & {c}^{″} & 0 \\ 0 & 0 & 1\end{matrix} ]$$

$$c = - \frac{{p}_{33}}{{( {p}_{32}^{2} + {p}_{33}^{2} )}^{1 / 2}} , s = \frac{{p}_{32}}{{( {p}_{32}^{2} + {p}_{33}^{2} )}^{1 / 2}}$$

$$…$$

$${PR}_{x} {R}_{y} {R}_{z} = K = > P = K {R}_{z}^{T} {R}_{y}^{T} {R}_{x}^{T} = KR$$

Now, the orientation parameter of the camera can be computed by R and the interior parameter of the camera can be computed by K.
For KRC=−m₄; C can also be computed and the position of the camera can be obtained.

As illustrated in FIG. 4G, once the refined camera parameters are computed, the virtual camera may then be repositioned in the 3-D environment from a location or orientation corresponding to the rough (or initial) camera parameters to a new location or orientation corresponding to the refined camera parameters.

As illustrated in FIG. 4H, once the virtual camera is repositioned, an updated image, such as a real-time surveillance video showing a coverage area of the real camera, may be integrated in the 3-D environment, for example, by projecting the updated image onto at least one portion of the 3-D environment as viewed from a position or orientation that corresponds to the refined camera parameters of the virtual camera. Since, as noted above, the refined camera parameters more closely reflect the current (or actual) camera parameters of the real camera than do the rough (or initial) camera parameters, this allows providing more precise virtual images for contexts (or environments) associated with the surveillance video. This in turn allows the operator to manage the surveillance in the 3-D virtual environment, which strongly enhances the operator's situation awareness.

In various embodiments, technology of shadow mapping may be used to integrate the updated image (e.g., surveillance video) into the 3-D environment. Shadow mapping is one of the popular methods for computing shadows. Shadow mapping is mainly based on 3-D rendering in pipe lined fashion of 3D rendering. In one example embodiment, shadow mapping may comprise two passes, as follows:
First pass: Render the scene from the light's position of view without light and color, and only store the depth of each pixel into a “shadow map”;
Second pass: Render the scene from the eye's position, but with the “shadow map” projected onto the scene from the position of light using the technology of projective texture, and then each pixel in the scene receives a value of depth form the position of light. At each pixel, the received value of depth is compared with the fragment's distance from the light. If the latter is greater, the pixel is not the closest one to the light, and it cannot be illuminated by the light.

As illustrated in FIG. 4I, the point P on the left figure may be determined to be in shadow because the depth of P (zB) is greater than the depth recorded in the shadow map (zA). In contrast, the point P on the right figure may be determined to be illuminated because the depth of P (zB) is equal to the depth of the shadow map (zA).

Shadow mapping may be applied to a coverage area of a camera. In order to project a predefined texture onto a scene (a window view of an application to display the 3-D model in the 3-D environment) to show the effect of the coverage area, a process of projecting coverage texture onto the scene may be added to the above two passes, and the light for the shadow mapping may be defined as the camera.

In various embodiments, the second pass may be modified. For each pixel rendered in the second stage, if a pixel can be illuminated from the light position (that is, the pixel can be seen from the camera), the color of the pixel may be blended with the color of the coverage texture projected from the camera position based on the projection transform of the camera. Otherwise, the original color of the pixel may be preserved. The flow of implementation of display of the coverage area is illustrated in FIG. 4J.

However, in some instances, as illustrated in FIG. 4K, it may not be reasonable to display the video mapping effect without considering the user's (e.g., administrator's or operator's) perspective because it may lead to serious distortion of the video and confuse the user. Applicants have realized that taking the user's perspective into consideration when displaying the projected video texture in the 3-D environment may allow avoiding distortion of the projected video. Applicants further have realized that it is beneficial to use perspective constraint to trigger and/or terminate display of video in the 3-D environment.

In various embodiments, for example, video distortion for rectangle ABCD (as illustrated in FIG. 4L) may be defined as follows:
a. Angle distortion

$${D}_{angle} = ‖ {θ}_{1} - \frac{π}{2} , {θ}_{2} - \frac{π}{2} , {θ}_{3} - \frac{π}{2} , {θ}_{4} - \frac{π}{2} ‖$$

b. Ratio distortion

$${D}_{ratio} = ‖ \frac{\vert AC \vert + \vert BD \vert}{\vert AB \vert + \vert CD \vert} - \frac{1}{{AspectRatio}_{camera}} ‖$$

c. Rotation distortion

$${D}_{rotation} = 1 - \frac{( AC + BD ) \cdot {( 0 , 1 )}^{T}}{\vert AC + BD \vert}$$

Distortion of the video may be computed as follows:
X X_{A}, X_{B}, X_{C}, X_{D} may denote the position of points A, B, C and D in the world coordinate, which can be calculated by ray casting in the 3D scene for a given camera.
xA, xB, xC, xD denote the position of points A, B, C and D projected to the 2D view port according to the user's perspective.
xλ (λ=A, B, C, D) can be calculated by the equation below:

x_{A}=PX_{λ}
(P is the projection matrix of user's perspective)
The distortion of video can be calculated by the following equation.

D=∥α_{angle}D_{angle}, αᵣₐₜᵢₒDᵣₐₜᵢₒ, αᵣₒₜₐₜᵢₒₙDᵣₒₜₐₜₒᵢₙ∥
(αλ (λ=angle, ratio, rotation) is the weight for each kind of distortion)

Then, the perspective constraint may be forced as follows: wherein Q_{D} is the failure threshold of mapping video in the 3D scene, according to the perspective of the current user, if D is greater than Q_{D} (i.e., D>Q_{D}), the display of video will be removed for serious distortion; otherwise, the video will be mapped to the 3D scene to enhance the situation awareness of the user. The flow of implementation of display of the coverage area is illustrated in FIG. 4M.

Camera drift of the real camera may be further detected in substantially real time based on discrepancy detected as a result of comparing the feature points. Once detected, a notification for the camera drift may be sent to the user and/or the real camera may be automatically adjusted using the above described camera registration methods.

Various embodiments described herein may comprise a system, apparatus and method of automating camera registration, and/or video integration in a 3D environment, using BIM semantic data and a real video. In the following description, numerous examples having example-specific details are set forth to provide an understanding of example embodiments. It will be evident, however, to one of ordinary skill in the art, after reading this disclosure, that the present examples may be practiced without these example-specific details, and/or with different combinations of the details than are given here. Thus, specific embodiments are given for the purpose of simplified explanation, and not limitation. Some example embodiments that incorporate these mechanisms will now be described in more detail.

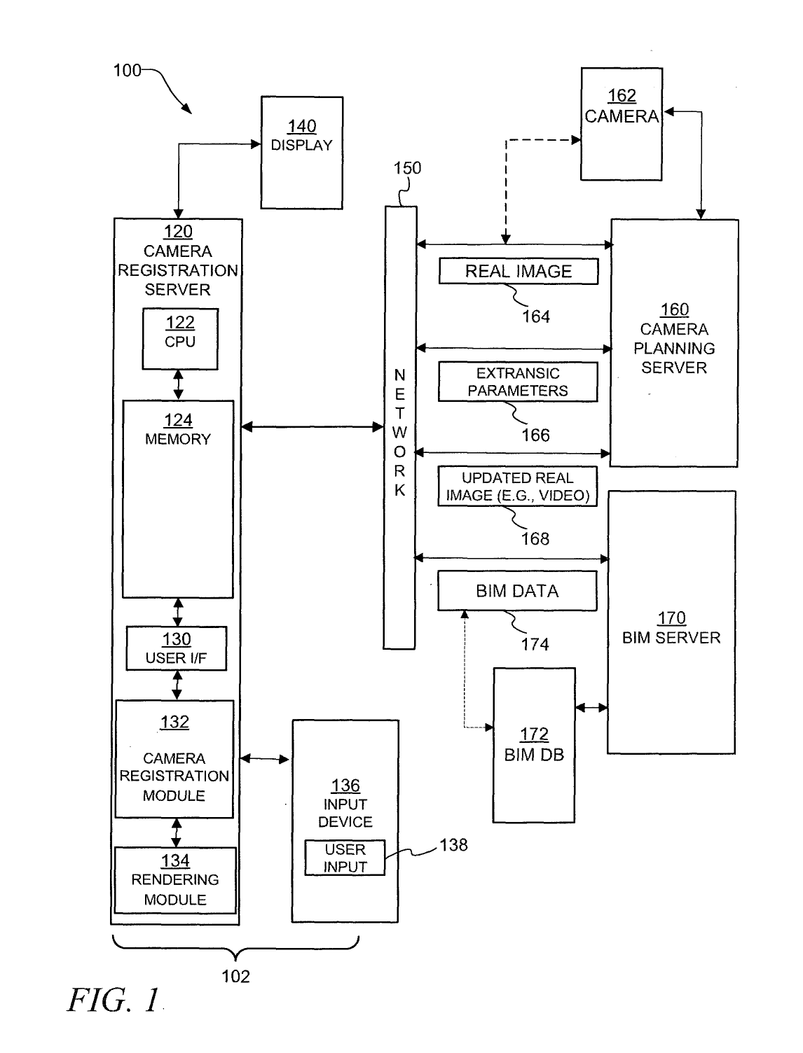

FIG. 1 is a block diagram of a system 100 to implement camera registration in 3-D geometry model according to various embodiments of the invention. Here it can be seen that the system 100 used to implement the camera registration in 3-D geometry model may comprise a camera registration server 120 communicatively coupled, such as via a network 150, with a camera planning server 160 and a building information model (BIM) server 170. The network 150 may be wired, wireless, or a combination of wired and wireless.

The camera registration server 120 may comprise one or more central processing units (CPUs) 122, one or more memories 124, a user interface (I/F) module 130, a camera registration module 132, a rendering module 134, one or more user input devices 136, and one or more displays 140.

The camera planning server 160 may be operatively coupled with one or more cameras 162, such as surveillance cameras installed in a building or other outdoor area (e.g., street or park, etc.). The camera planning server 160 may store extrinsic parameters 166 for at least one of the one or more cameras 162 as registered at the time the at least one camera 162 is physically installed in the building or other outdoor area. Also, the camera planning server 160 may receive one or more real images 164, such as surveillance images, from a corresponding one of the one or more cameras 162 in real time and then present the received images to a user (e.g., administrator) via its one or more display devices 140 or provide the received images to another system, such as the camera registration server 120, for further processing. In one example embodiment, the camera planning server 160 may store the received image in its associated one or more memories 124 for later use.

The BIM server 170 may store BIM data 174 for a corresponding one of the building or other outdoor area. In one example embodiment, the BIM server 170 may be operatively coupled with a BIM database 172 locally or remotely, via the network 150 or other network (not shown in FIG. 1). The BIM server 170 may provide the BIM data 174 to another system, such as the camera registration server 120, directly or via the BIM database 172, in response to receiving a request from the other system or periodically without receiving any request from the other system.

In various embodiments, the camera registration server 120 may comprise one or more processors, such as the one or more CPUs 122, to operate the camera registration module 132. The camera registration module 132 may be configured to receive a real image 164 of a coverage area of a surveillance camera. The coverage area may correspond to at least one portion of a surveillance area. The camera registration module 132 may receive BIM data 174 associated with the coverage area. The camera registration module 132 may generate a virtual image based on the BIM data 174, for example, using the rendering module 134. The virtual image may include at least one three-dimensional (3-D) image that substantially corresponds to the real image 164. The camera registration module 132 may map the virtual image with the real image 164. Then, the camera registration module 132 may register the surveillance camera in a BIM coordination system using an outcome of the mapping.

In various embodiments, the camera registration module 132 may be configured to generate the virtual image based on initial extrinsic parameters 166 of the surveillance camera. The initial extrinsic parameters 166 may be parameters used at the time the surveillance camera is installed in a relevant building or area. In one example embodiment, the initial extrinsic parameters 166 may be received as one or more user inputs 138 from a user (e.g., administrator) of the camera registration server 120 via one or more of the input devices 136. In yet another example embodiment, the initial extrinsic parameters 166 may be imported from the camera planning server 160 or a camera installation system (not shown in FIG. 1).

In various embodiments, for example, to perform the mapping between the virtual image and the real image 164, the camera registration module 132 may be configured to match a plurality of pairs of points on the virtual image and the real image 164, calculate at least one geometry coordination for a corresponding one of the points on the virtual image, and calculate refined extrinsic parameters (not shown in FIG. 1) for the surveillance camera using the at least one geometry coordination.

In various embodiments, each of the plurality of points may comprise a vertex associated with a geometric feature extracted from a corresponding one of the virtual image or the real image 164. In one example embodiment, the geometric feature associated with the virtual image may be driven using semantic information of the BIM data 174. For example, the geometric feature may comprise a shape or at least one portion of a boundary line of an object or a building structure (e.g., door, desk or wall, etc.) viewed in a corresponding one of the virtual image or the real image 164.

In various embodiments, for example, during the matching between the virtual image and the real image 164, the camera registration module 132 may be configured to mark at least one of the plurality of pairs as matching a function of the user input 138 received from the user (e.g., administrator), for example, via one or more of the input devices 136. The camera registration module 132 may further be configured to remove at least one pair of points from a group of automatically suggested pairs of points as a function of a corresponding user input.

In various embodiments, the camera registration module 132 may be configured to display at least a portion of the mapping process via a display unit, such as the one or more displays 140.

In various embodiments, for example, to perform the registering of the surveillance camera in the BIM coordination system, the camera registration module 132 may be configured to calculate refined extrinsic parameters of the surveillance camera using the outcome of the mapping. For example, camera registration equation as described earlier may be used to calculate the refined extrinsic parameters. The refined extrinsic parameters may include information indicating a current location and a current orientation of the surveillance camera in the BIM coordination system.

In various embodiments, the registration module 132 may be configured to present, via a display unit, such as the one or more displays 140, the coverage area in three dimensional (3-D) graphics using the refined extrinsic parameter. The registration module 132 may be further configured to highlight the coverage areas as distinguished from non-highlighted portion of the 3-D graphics displayed via the display 140, for example, using a different color or texture or a combination thereof, etc.

In various embodiments, the camera registration module 132 may be further configured to project updated real image 168, such as updated surveillance video, on a portion of the coverage area displayed via the display 140. The updated real image 168 may be obtained directly from the surveillance camera in real time or via a camera management system, such as the camera planning server 160.

In various embodiments, the camera registration module 132 may be configured to inhibit display of at least one portion of the updated real image 168 based on a constraint on a user perspective. The camera registration module 132 may be configured to determine the user perspective using the refined extrinsic parameters. In one example embodiment, the user perspective may comprise a cone shape or other similar shape.

In various embodiments, the camera registration module 132 may be configured to use the rendering module 134 to render any graphical information via the one or more displays 140. For example, the camera registration module 132 may be configured to control the rendering module 134 to render at least one portion of the virtual image, real image 164, updated real image 168, or the mapping process between the virtual image and the real image 164, etc. Also, the camera registration module 132 may be configured to store at least one portion of images from the one or more cameras 162, the BIM data 174, or the virtual image generated using the BIM data 174 in a memory device, such as the memory 124.

In various embodiments, the camera registration module 132 may be further configured to detect a camera drift of a corresponding one of the one or more cameras 162 using the refined extrinsic parameters (not shown in FIG. 1). In one example embodiment, the camera registration module 132 may be configured to compare the initial extrinsic parameters 166 with the refined extrinsic parameters and trigger an alarm of a camera drift event based on a determination that a difference between the initial extrinsic parameters 166 and the refined extrinsic parameters reaches a specified threshold. Once the camera drift is detected for a camera 162, the camera 162 may be adjusted to its original or any other directed position manually, automatically or a combination thereof.

In various embodiments, the camera registration module 132 may be configured to determine refined extrinsic parameters of a corresponding one of the one or more cameras 162 periodically. In one example embodiment, for a non-initial iteration (i.e., 2^{nd}, 3^{rd} . . . N^{th}) of determining the refined extrinsic parameters, the camera registration module 132 may be configured to use the refined extrinsic parameters determined for a previous iteration (e.g., 1^{st} iteration) as new initial extrinsic parameters 166. The refined extrinsic parameters 166 calculated for each iteration may be stored in a relevant memory, such as the one or more memories 124, for later use.

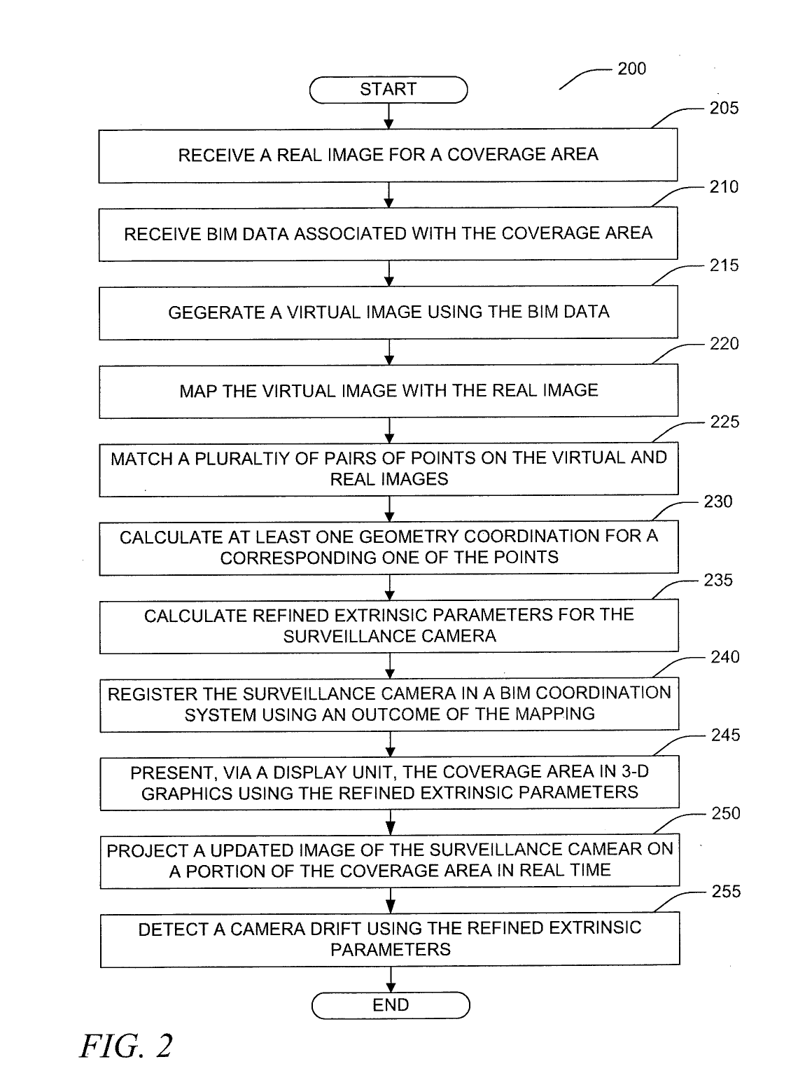

Each of the modules described above in FIG. 1 may be implemented by hardware (e.g., circuit), firmware, software or any combinations thereof Although each of the modules is described above as a separate module, the entire modules or some of the modules in FIG. 1 may be implemented as a single entity (e.g., module or circuit) and still maintain the same functionality. Still further embodiments may be realized. Some of these may include a variety of methods. The system 100 and apparatus 102 in FIG. 1 can be used to implement, among other things, the processing associated with the methods 200 of FIG. 2 discussed below.

FIG. 2 is a flow diagram illustrating methods of automating camera registration in a 3-D geometry model according to various embodiments of the invention. The method 200 may be performed by processing logic that may comprise hardware (e.g., dedicated logic, programmable logic, microcode, etc.), software (such as run on a general purpose computer system or a dedicated machine), firmware, or a combination of these. In one example embodiment, the processing logic may reside in various modules illustrated in FIG. 1.

A computer-implemented method 200 that can be executed by one or more processors may begin at block 205 with receiving a real image for a coverage area of a surveillance camera. The coverage area may correspond to at least one portion of a surveillance area. At block 210, Building Information Model (BIM) data associated with the coverage area may be received. At block 215, a virtual image may be generated using the BIM data. The virtual image may include at least one three-dimensional (3-D) image substantially corresponding to the real image. At block 220, the virtual image may be mapped with the real image. Then, at block 240, the surveillance camera may be registered in a BIM coordination system using an outcome of the mapping.

In various embodiments, the mapping of the virtual image with the real image may comprise matching a plurality of pairs of points on the virtual image and the real image, calculating at least one geometry coordination for a corresponding one of the points on the virtual image, and calculating refined extrinsic parameters for the surveillance camera using the at least one geometry coordination, as depicted at blocks 225, 230 and 235, respectively.

In various embodiments, at block 245, the computer-implemented method 200 may further present, via a display unit, such as the one or more displays 140 in FIG. 1, the coverage area in 3-D graphics using the refined extrinsic parameters. In one example embodiment, the coverage area may be highlighted using a different color or texture or a combination thereof to distinguish from non-highlighted displayed area. At block 250, an updated image (e.g., surveillance video) may be imported from the surveillance camera, and then projected on a portion of the coverage area displayed in the 3-D graphics in substantially real time. In various embodiments, at block 255, a camera drift of the surveillance camera may be detected using the refined extrinsic parameters. In one example embodiment, the detecting of the camera drift may comprise comparing the initial extrinsic parameters with the refined extrinsic parameters and triggering an alarm of a camera drift event based on a determination that a difference between the initial extrinsic parameters and the refined extrinsic parameters reaches a specified threshold.

Although only some activities are described with respect to FIG. 2, the computer-implemented method 200 may perform other activities, such as operations performed by the camera registration module 132 of FIG. 1, in addition to and/or in alternative to the activities described with respect to FIG. 2.

The methods described herein do not have to be executed in the order described, or in any particular order. Moreover, various activities described with respect to the methods identified herein can be executed in repetitive, serial, heuristic, or parallel fashion. The individual activities of the method 200 shown in FIG. 2 can also be combined with each other and/or substituted, one for another, in various ways. Information, including parameters, commands, operands, and other data, can be sent and received in the form of one or more carrier waves. Thus, many other embodiments may be realized.

The method 200 shown in FIG. 2 can be implemented in various devices, as well as in a computer-readable storage medium, where the method 200 is adapted to be executed by one or more processors. Further details of such embodiments will now be described.

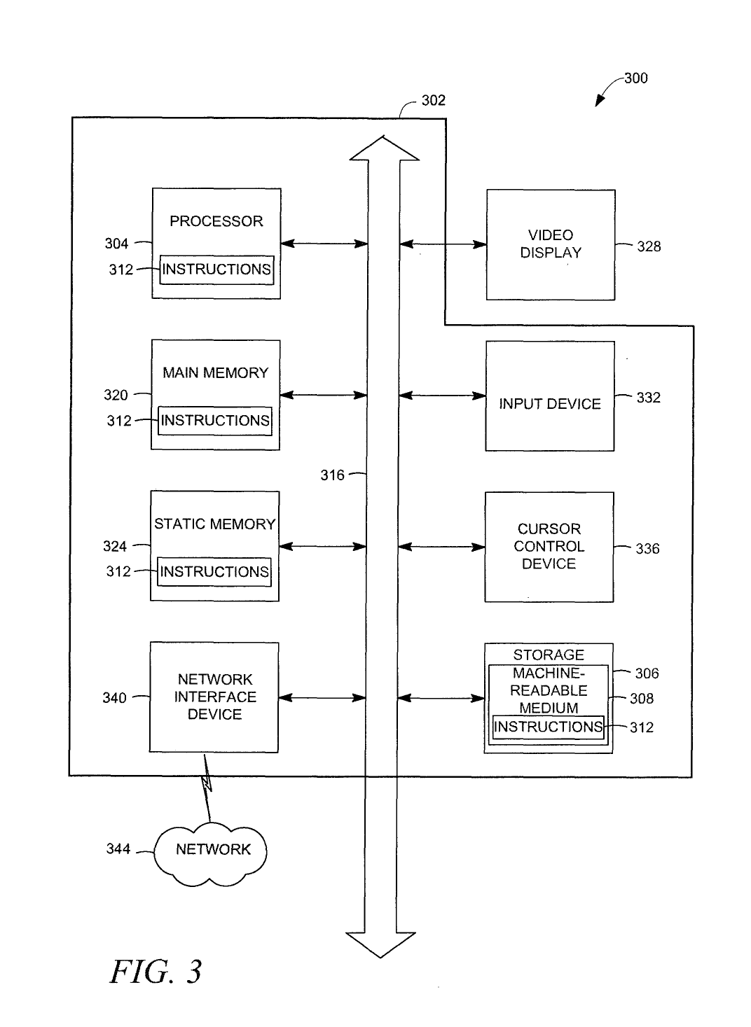

For example, FIG. 3 is a block diagram of an article 300 of manufacture, including a specific machine 302, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-oriented format using an object-oriented language such as Java or C++. Alternatively, the programs can be structured in a procedure-oriented format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 300 of manufacture, such as a computer, a memory system, a magnetic or optical disk, some other storage device, and/or any type of electronic device or system may include one or more processors 304 coupled to a machine-readable medium 308 such as a memory (e.g., removable storage media, as well as any memory including an electrical, optical, or electromagnetic conductor) having instructions 312 stored thereon (e.g., computer program instructions), which when executed by the one or more processors 304 result in the machine 302 performing any of the actions described with respect to the methods above.

The machine 302 may take the form of a specific computer system having a processor 304 coupled to a number of components directly, and/or using a bus 316. Thus, the machine 302 may be similar to or identical to the apparatus 102 or system 100 shown in FIG. 1.

Returning to FIG. 3, it can be seen that the components of the machine 302 may include main memory 320, static or non-volatile memory 324, and mass storage 306. Other components coupled to the processor 304 may include an input device 332, such as a keyboard, or a cursor control device 336, such as a mouse. An output device such as a video display 328 may be located apart from the machine 302 (as shown), or made as an integral part of the machine 302.

A network interface device 340 to couple the processor 304 and other components to a network 344 may also be coupled to the bus 316. The instructions 312 may be transmitted or received over the network 344 via the network interface device 340 utilizing any one of a number of well-known transfer protocols (e.g., HyperText Transfer Protocol and/or Transmission Control Protocol). Any of these elements. coupled to the bus 316 may be absent, present singly, or present in plural numbers, depending on the specific embodiment to be realized.

The processor 304, the memories 320, 324, and the mass storage 306 may each include instructions 312 which, when executed, cause the machine 302 to perform any one or more of the methods described herein. In some embodiments, the machine 302 operates as a standalone device or may be connected (e.g., networked) to other machines. In a networked environment, the machine 302 may operate in the capacity of a server or a client machine in server-client network environment, or as a peer machine in a peer-to-peer (or distributed) network environment.

The machine 302 may comprise a personal computer (PC), a tablet PC, a set-top box (STB), a PDA, a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 302 is illustrated, the term “machine” shall also be taken to include any collection of machines that individually or jointly execute a set (or multiple sets) of instructions to perform any one or more of the methodologies discussed herein.

While the machine-readable medium 308 is shown as a single medium, the term “machine-readable medium” should be taken to include a single medium or multiple media (e.g., a centralized or distributed database, and/or associated caches and servers, and/or a variety of storage media, such as the registers of the processor 304, memories 320, 324, and the mass storage 306 that store the one or more sets of instructions 312). The term “machine-readable medium” shall also be taken to include any medium that is capable of storing, encoding or carrying a set of instructions for execution by the machine 302 and that cause the machine 302 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Embodiments of the invention can be implemented in a variety of architectural platforms, operating and server systems, devices, systems, or applications. Any particular architectural layout or implementation presented herein is thus provided for purposes of illustration and comprehension only, and is not intended to limit the various embodiments.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
one or more processors to operate a registration module, the registration module configured to:
(a) receive a real image of a coverage area of a surveillance camera, the coverage area corresponding to at least one portion of a surveillance area;
(b) receive Building Information Model (BIM) data associated with the coverage area;
(c) generate a virtual image using the BIM data, the virtual image including at least one three-dimensional (3-D) graphics substantially corresponding to the real image;
(d) map the virtual image with the real image; and
(e) register the surveillance camera in a BIM coordination system using an outcome of the mapping.

2. The system of claim 1, wherein the generation of the virtual image is based on initial extrinsic parameters of the surveillance camera.

3. The system of claim 2, wherein the initial extrinsic parameters are received as one or more user inputs or imported from a camera planning system or a camera installation system.

4. The system of claim 1, wherein the mapping comprises:
matching a plurality of pairs of points on the virtual image and the real image;
calculating at least one geometry coordination for a corresponding one of the points on the virtual image; and
calculating refined extrinsic parameters for the surveillance camera using the at least one geometry coordination.

5. The system of claim 4, wherein each point in the plurality of pairs of points comprises a vertex associated with a geometric feature extracted from a corresponding one of the virtual image or the real image.

6. The system of claim 5, wherein the geometric feature associated with the virtual image is driven from the BIM data.

7. The system of claim 5, wherein the geometric feature comprises a shape or at least one portion of a boundary line of an object or a building structure viewed in a corresponding one of the virtual image or the real image.

8. The system of claim 4, wherein the matching comprises marking at least one of the plurality of pairs as matching as a function of a user input.

9. The system of claim 4, wherein the matching comprises removing at least one pair of points from a group of automatically suggested pairs of points as a function of a corresponding user input.

10. The system of claim 1, further comprising a display unit, wherein the registration module is configured to display the mapping of the virtual image with the real image via the display unit.

11. The system of claim 1, wherein the registering comprises calculating refined extrinsic parameters of the surveillance camera, the refined extrinsic parameters including a current location and a current orientation of the surveillance camera in the BIM coordinate system.

12. The system of claim 11, further comprising a display unit, wherein the registration module is configured to present, via the display unit, the coverage area in three dimensional (3-D) graphics using the refined extrinsic parameters.

13. The system of claim 12, wherein the presenting comprises highlighting the coverage area.

14. The system of claim 12, wherein the presenting comprises projecting an updated image on a portion of the coverage area, the updated image being obtained from the surveillance camera in real time.

15. The system of claim 14, wherein the projecting comprises inhibiting display of at least one portion of the updated image based on a constraint on a user perspective.

16. The system of claim 15, wherein the user perspective comprises a cone shape determined based on the refined extrinsic parameters.

17. The system of claim 11, wherein the registration module is further configured to detect a camera drift using the refined extrinsic parameters, wherein the detecting the camera drift comprises:
comparing the refined extrinsic parameters with initial extrinsic parameters of the surveillance camera; and
triggering an alarm of a camera drift event based on a determination that a difference between the initial extrinsic parameters and the refined extrinsic parameters reaches a specified threshold.

18. The system of claim 11, wherein the refined extrinsic parameters of the surveillance camera are calculated periodically.

19. A computer-implemented method comprising:
(a) receiving, using one or more processors, a real image of a coverage area of a surveillance camera, the coverage area corresponding to at least one portion of a surveillance area;
(b) receiving Building Information Model (BIM) data associated with the coverage area;
(c) generating a virtual image using the BIM data, the virtual image including at least one three-dimensional (3-D) graphics substantially corresponding to the real image;
(d) mapping the virtual image with the real image; and
(e) registering the surveillance camera in a BIM coordination system using an outcome of the mapping.

20. A non-transitory computer-readable storage medium storing instructions which, when executed by one or more processors, cause the one or more processors to perform operations comprising:
(a) receiving a real image of a coverage area of a surveillance camera, the coverage area corresponding to at least one portion of a surveillance area;
(b) receiving Building Information Model (BIM) data associated with the coverage area;
(c) generating a virtual image using the BIM data, the virtual image including at least one three-dimensional (3-D) graphics substantially corresponding to the real image;
(d) mapping the virtual image with the real image; and
(e) registering the surveillance camera in a BIM coordination system using an outcome of the mapping.
